(19) United States
(12) Patent Application Publication
(10) Pub. No.: US 2012/0256920 A1
(43) Pub. Date: Oct. 11, 2012

(54) System and Method for Fusing Computer Assisted Detection in a Multi-Modality, Multi-Dimensional Breast Imaging Environment

(76) Inventors: Julian Marshall, Los Altos, CA (US); John LaViola, Orange, CT (US); Andrew Smith, Lexington, MA (US)

(21) Appl. No.: 13/440,219

(22) Filed: Apr. 5, 2012

Related U.S. Application Data
(63) Continuation-in-part of application No. 13/325,495, filed on Dec. 14, 2011.
(60) Provisional application No. 61/471,933, filed on Apr. 5, 2011.

(51) Int. Cl. G06T 17/00

(52) U.S. Cl. 345/420

(57) ABSTRACT

A multi-modality cancer screening and diagnosis system fuses CAD information obtained by imaging an immobilized patient using multiple different image acquisition systems to provide a single fused CAD data set. Combining the CAD results of multiple modalities into a single, rich, data set allows the strengths of each imaging modality to be leveraged to improve the sensitivity and specificity of breast cancer diagnosis. The CAD results may be used, together with fused image data, to train a CAD algorithm which may be used to directly process a fused multi-mode image data set.

### RELATED APPLICATIONS

This application is related, and claims priority under 35 U.S.C. 1.119(e), to provisional application Ser. No. 61/471,933, filed Apr. 5, 2011, and entitled “Multi-Modality, Multi-Dimensional Breast Imaging CAD”, incorporated herein by reference.

This application is related, and claims priority as a continuation-in-part under 35 U.S.C. §1.20, to U.S. patent application Ser. 13/325,495, which was filed on Dec. 14, 2011 by the same assignee as the present application, and entitled “System and Method for Fusing Three Dimensional Image Data from a Plurality of Different Imaging Systems for Use in Diagnostic Imaging”, which claims priority to U.S. Provisional Application 61/264,743, filed Nov. 27, 2009 and U.S. Provisional Application 61/394,734, filed Oct. 19, 2010, all of which are incorporated herein by reference.

### BACKGROUND

Medical imaging devices provide non-invasive methods to visualize the internal structure of a patient. Such non-invasive visualization methods can be helpful in treating patients for various ailments. For example, the early detection of cancer in a patient can be important in treating that patient. For most cancers, when detected at an early stage, the survival probability of the patient can increase.

Different breast imaging modalities provide complementary information about normal and abnormal tissue, anatomy and function, and are increasingly being used together during breast cancer screening and/or diagnosis in an effort to improve the sensitivity and specificity of a diagnosis. For example, X-ray mammography provides information about breast tissue density and is a preferred imaging mode for visualization of breast calcifications, X-ray tomosynthesis generates a three-dimensional volume of the breast and used to visualize masses and other structures which may be difficult to view in 2D mammography due to overlapping structures, dynamic contrast enhanced MRI (DCE-MRI) provides functional and pathological information such as angiogenesis, and ultrasound imaging is often used during initial breast cancer diagnosis for characterization of a mass or region of interest. As an increasing number of women are being imaged by more than one modality, there is an increased demand to provide radiologists with automated tools to fuse information from two or more modalities to increase the sensitivity and specificity of breast cancer diagnosis.

### SUMMARY

According to one aspect of the invention, it is realized that improved specificity and sensitivity in diagnosis can be realized by merging Computer Assisted Detection results obtained from processing images acquired via multiple imaging modalities. A method of generating a fused Computer Assisted Detection (CAD) data set includes the steps of obtaining a plurality of image data sets, each data set acquired using a different image modality, generating a personalized CAD data set for each of the image data sets, mapping each image data set to a common coordinate system, including mapping each personalized CAD data set to the common coordinate system, and combining the CAD data sets within the common coordinate system to provide the fused CAD data set. According to one aspect of the invention, the fused CAD data set may then be re-projected onto the coordinate systems of any of the imaging modalities to thereby allow viewing of a particular image data set (or a fused image data set) with CAD data integrated from multiple modalities. With such an arrangement, region of interest detection information associated with one imaging modality may be viewed with image data from a different modality. According to another aspect of the invention, a user interface may be provided that enables a user to selectively control the particular CAD data which is included in a fused CAD data set.

According to another aspect of the invention, a system includes a computer readable medium having a data structure stored thereon, the data structure comprising a data volume including fused Computer Assisted Detection (CAD) information, the CAD information obtained by executing one or more CAD processes on a plurality of image data sets, the image data sets acquired using a plurality of image acquisition systems of different modalities. The system further includes a transform mechanism, operable to transform the data volume from a first coordinate system to a coordinate system specific to a selected display geometry. With such an arrangement, fused CAD data may be overlaid and displayed with image data of any image modality, allowing, for example, breast density information (obtained from mammography CAD) to be combined with other CAD information, including but not limited to breast mass information (obtained from tomosynthesis CAD) and breast functional and pathological information (obtained from DCE-MRI CAD), thereby enabling increased sensitivity and specificity for breast cancer diagnosis.

These and other aspects of the present invention will be described in more detail with regard to the Figures identified below.

### DESCRIPTION OF THE FIGURES

FIG. 1 is a block diagram of one embodiment of a system which illustrates a plurality of coupled image acquisition devices of different modalities and a Computer Assisted Detection (CAD) module of the present invention which may process acquired images to generate personalized CAD results for each image data set, and selectively fuse one or more of the personalized CAD results;

FIG. 2 is a flow diagram illustrating exemplary steps that may be included in a process of the present invention for building a fused CAD data set;

FIG. 3 is a block diagram of exemplary components that may be included in an image processing system which provides personalized CAD results for images provided by different acquisition systems;

FIG. 4 is a data flow diagram provided to illustrate the flow of data from an image acquisition device through a transform process to provide fused CAD results, and the subsequent data flow for displaying they fused CAD results on one or more display devices; and

FIG. 5 is a data flow diagram provided to illustrate the analysis of a fused image data set using a CAD process which has been trained using fused CAD results generated according to processes similar to FIG. 4.

### DETAILED DESCRIPTION

A multi-modality cancer screening and diagnosis system will now be described which enables CAD information obtained by imaging an immobilized patient using multiple different image acquisition systems to be mapped to a common coordinate geometry and combined into a single fused CAD data set. When a user seeks to view an image data set associated with a selected geometry, the fused CAD data set is projected onto the selected geometry for display with image data. For example, the present invention may be used generate a single fused CAD data set that combines CAD data obtained from a series of one or more scans (i.e., an x-ray tomosynthesis scan and an ultrasound scan) of a patients immobilized breast. As will become apparent herein, the present invention is not limited to any particular type of image scan, nor is it limited to combination of scans of the same order (i.e., 2D or 3D). Rather, the present invention envisions the fusing of CAD data sets obtained from mammography, tomosynthesis, magnetic resonance imaging (MRI), SPECT, PET, gamma, Computed Tomography image acquisition systems and the like. Combining the CAD results of multiple modalities into a single, rich, data set allows the strengths of each imaging modality to be leveraged to improve the sensitivity and specificity of breast cancer diagnosis.

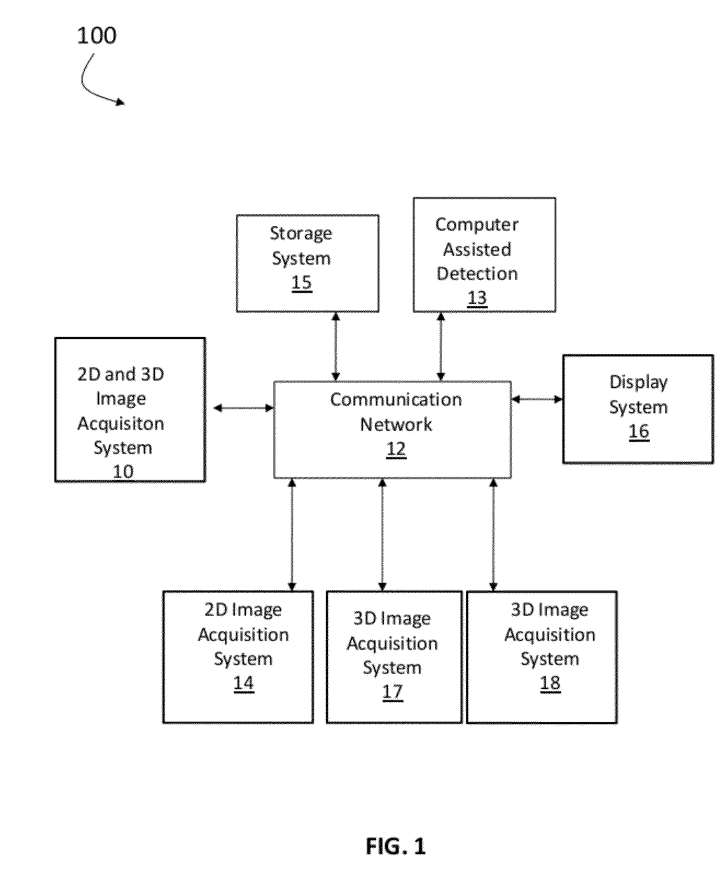

Referring now to FIG. 1, an embodiment of an exemplary system 100 in which the present invention may be incorporated is shown. The system uses established communication standards for inputting medical images, and is able to handle various input sources, including films/screens of various types, and digital inputs of various resolutions. Furthermore, the system may be able to work with two as well as three-dimensional image data.

System 100 is shown to include a Computer Assisted Detection (CAD) module 13 which is coupled via a communication link 12 to a storage system 15 and a display system 16, as well as to two or more image acquisitions systems, such as 2D image acquisition system 14, 3D image acquisition systems 17 and 18, and a combination 2D and 3D image acquisition system 10. The 2D image acquisition systems may include any image acquisition system which provides, as output, a 2D image including x-ray mammography, ultrasound systems and the like. One example of a 2D mammography system which may be used with the present invention is the Selenia® Breast Imaging System provided by Hologic, Inc., of Bedford Mass. The 3D image acquisition systems may include any image acquisition system which generates a 3D image volume, for example, tomosynthesis imaging systems, Computed tomography systems, Magnetic Resonance, gamma imaging systems, Single Photon Emission Computed Tomography (SPECT) or Positron Emission Tomography (PET) systems, etc. The combination 2D and 3D system may be, for example, the Selenia® Dimensions® Breast Tomosynthesis system, also provided by Hologic, Inc., the assignee of the present invention. However it should be noted that although particular examples of systems are shown and described, the present invention is not limited to use in an imaging environment that includes any particular combination of 2D or 3D image acquisition systems. Rather, an important aspect of the present invention is that it is allows for seamless integration of CAD data from any two of many different imaging modalities, thus allowing the particular strengths of each imaging modality to be reflected into a single, intelligent, fused data set.

It should be noted that, although the ‘systems’ and ‘modules’ are shown in FIG. 1 as functional blocks, different systems or modules may be integrated into a common device or broken into components of smaller granularity, and the communication link may be coupled between fewer than all of the systems; for example, the CAD module and display system may be included in an acquisition work station or a technologist work station which may also control the acquisition of the x-ray, MRI or SPECT/PET images in a radiology suite. Similarly, skilled persons will additionally appreciate that communication network 12 can be a local area network, wide area network, wireless network, internet, intranet, or other similar communication network.

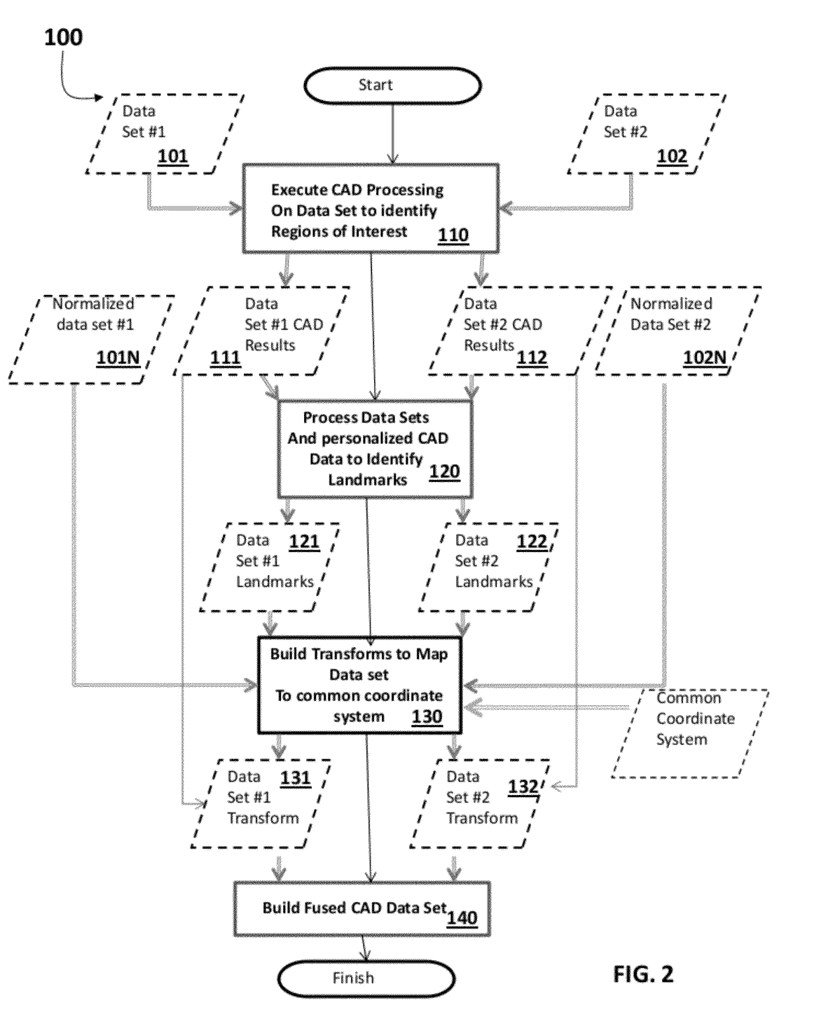

Thus although the CAD module is shown as one functional block, according to one aspect of the invention the CAD module includes at least the functionality described in FIG. 2 for performing CAD processing of any images received from the image acquisition systems, and for transforming the CAD data into a single fused data set. It is appreciated that the particular functions may in fact be performed by different software programs executing on a common workstation or alternatively on networked processing devices which exchange data via a communication link or via access to a shared memory device. In addition, although the steps in FIG. 2 are represented and described as being serially performed, this is for convenience of description only. It is known in the art that increased performance may be obtained via parallel or pipelined processing, and such techniques are considered as equivalents embodiments hereof. An exemplary process flow which may be followed by the CAD module to provide a fused CAD data set will now be described with reference to the functional flow diagram of FIG. 2.

The process of building a fused CAD data set begins with processing (at step 110) acquired image data (101, 102) from image acquisition devices to obtain the CAD data (111, 112, respectively) that is personal to that particular acquisition method. This personalized CAD data 111, 112 may be stored in storage system 15. In general, the CAD processing may be trained to identify features that may be of interest in the particular image data set, where the ‘training’ of a CAD system involves analysis of image data received from each type of image acquisition device. CAD algorithms assign numerical values, weights or thresholds, to pixels or regions based upon detected features within the region. The features may include, for example, speculated lesions, calcifications and the like. Various systems and methods are currently known for computerized detection of abnormalities in radiographic and other forms of images, such as those disclosed by Giger et al. in RadioGraphics, May 1993, pp. 647 656; Giger et al. in Proceedings of SPIE, Vol. 1445 (1991), pp. 101 103; U.S. Pat. No. 4,907,156 to Doi et al.; U.S. Pat. No. 5,133,020 to Giger et al.; U.S. Pat. No. 5,343,390 to Doi et al.; U.S. Pat. No. 5,491,627 to Zhang et al.

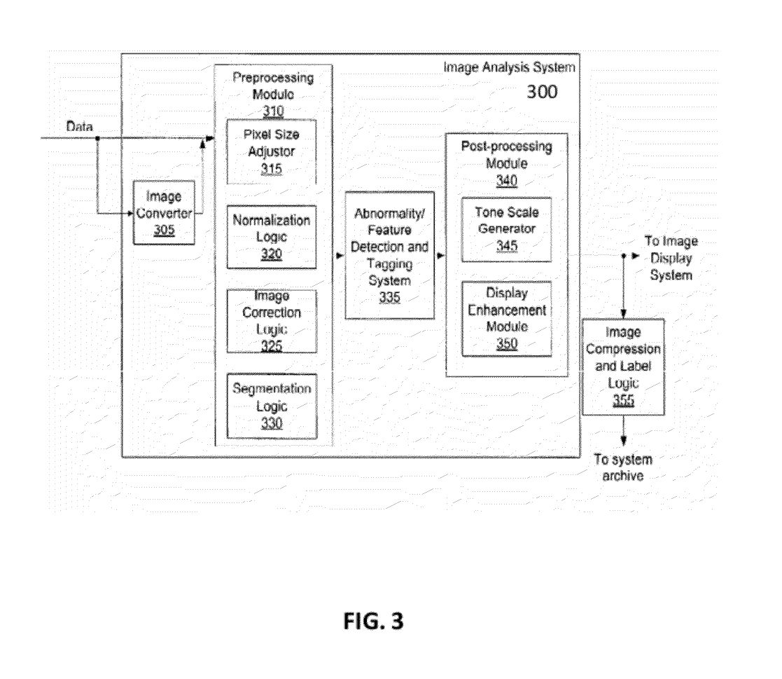

One exemplary image analysis system which processes images to generate a personalized CAD data is shown as image system 300 in FIG. 3. The system 300 includes an image converter 305 which converts non-digital images to digital images. For one embodiment, the image converter 305 also converts the image into a standard format, such as DICOM, or General Electric's proprietary format HL7. For one embodiment, this includes adding patient information.

The system 300 includes a preprocessing module 310, which receives the digital image data from image acquisition modules. The pre-processing module 310 includes a pixel size adjustor. The pixel size adjustor 315 provides the ability to process images with a wide range of pixel sizes. For example, mammography images may be input with 50 micron pixels, 100 micron pixels, 86 micron, etc. The pixel size adjustor 315 is able to accept all sizes of inputs, and delivers a standardized output, having a preselected pixel size. The standardization performed by pixel size adjustor 315 facilitates abnormality detection, since the image resolution is identical for all input formats.

The algorithm used by the abnormality detection system 335 typically looks for abnormalities at well-defined scales, or sizes. For example, micro-calcifications in mammograms are very small, often 100 to 250 microns in size. Digital filters with high sensitivity at those scales would be used to detect such micro-calcifications. In contrast, masses are generally larger than 5 mm when visible. Thus, a different detection algorithm would be used to detect masses. Furthermore, the size of the abnormal object is an important parameter, and many algorithms incorporate the knowledge of size, and therefore pixel size into the analysis of the object. In addition, different detection algorithms may be used with contrast enhanced images, for example to monitor washout within regions over time. An optimal pixel size, or “canonical” pixel size is usually chosen, that is appropriate to the type of image being analyzed, and the algorithms being used although this is not a requirement of the invention. When an image is input with a different pixel size, it is converted into the canonical size so the algorithm can operate correctly on it. If the input image is larger than the canonical size, this may be accomplished by sub-sampling or filtering down. If the input image is smaller, this can be accomplished by interpolating up to the larger size.

Using such pixel size adjusting is a useful component of a system that accepts images from different acquisition devices, such as film/screen, computed radiography, or digital acquisition devices. The normalization and contrast equalization (NACE) logic 320 processes the images to generate gray-scale values that are indicative, as much as possible, of anatomy only. The NACE logic 320 processes the images to generate gray-scale values that are sensitive, as much as possible, to contrast changes due anatomy, rather than incidental variables such as x-ray technique, exposure, energy, etc. A substantial benefit of this operation is that CAD accuracy, i.e. sensitivity and specificity, is generally improved. This is because CAD ultimately attempts to separate abnormalities from normal structure by looking for physical variables (such as contrast) where the distribution of the variable values differs between normal and abnormal. In general, by eliminating incidental variables and allowing pixel gray values to better reflect real differences in anatomy, the distributions of these physical variables will become narrower, thus allowing better separation. Thus, the NACE logic 320 produces an output that is generally independent of acquisition technique, compression, mechanical idiosyncrasies, etc. The mechanics of implementing the NACE logic 320 is explained in more detail in U.S. Pat. No. 7,054,473, incorporated herein by reference.

The image correction logic 325 performs image correction appropriate to the anatomical features being analyzed. Thus, image correction may include correction for noise, correction for tilt, or other aspects of the image. For one embodiment, image correction logic 325 further performs a preliminary analysis on the quality of the image. If the image quality is not sufficient for feature detection, the system may request that a new image be taken. If the image analysis system 300 is on the same system as the image acquisition, this process may be performed immediately. In that instance, the notification that a new image should be taken may be very fast, taking only a few seconds. This is advantageous since it means that the patient is not required to return for a new image to be taken.

Segmentation logic 330 may be used to segment the various body parts. Segmentation is an operation that assigns all image pixels that share some trait in common to a single class. As an example, segmentation algorithms such as described in U.S. Pat. No. 5,452,367 by Bick et al.; may be used to find the skin line of a breast, thus assigning all pixels inside the skin line to the “breast region,” and all pixels outside to be in the background region. A further example that would be relevant in chest radiography is code that would segment the lung fields in a chest image, such as described by Bram Van Ginneken (Bram van Ginneken, Computer-Aided Diagnosis in Chest Radiography, Ph.D Thesis, Image Sciences Institute, University Medical Center Utrecht, Utrecht, Netherlands). Segmentation algorithms may be used to further segment the chest image into mediastinem, heart, diaphragm, ribs, etc. In other medical images, segmentation might be used to separate different organs in the image.

The normalized and segmented image is then passed to the abnormality and feature detection and tagging system 335. This module may use one or more of the existing systems designed for the purpose. Examples have been described, for example, in U.S. Pat. Nos. 6,263,092; 6,198,838; 5,289,374; 5,657,362; and 5,537,485, each of which is incorporated herein by reference. For one embodiment, the findings or results, positive or negative in nature, from the abnormal detection system 335 are in the form of a two-dimensional annotation map or x-y coordinate information, of the locations of the CAD-detected abnormalities. This module 335 will output a data stream that may include one or more of the following: locations and sizes of lesions, classifications of lesions, descriptors of lesions, linear, area and volumetric measurements of lesions, information regarding the success and failure of each algorithm attempted, including whether or not processing was a success, and the list of evidence used in the processing. The output will contain the location or x-y coordinate of the detected region of interest, whether a centroid, outline, perimeter, circumscribed circle or other localization, and will contain information describing what was located, and may optionally describe how the region or finding correlates spatially, temporally, or otherwise to other findings or anatomic structures.

The post-processing module 340 further processes the image. For one embodiment, the image at this point may include the abnormality tags, or other indicators from feature detection system 335. For another embodiment, the post-processing module 340 may receive the images directly from the pre-processing module 310.

Referring back again to FIG. 2, the result of image processing by the system of FIG. 3 includes normalized image data 101N and 102N, and personalized CAD data sets 111, 112. The CAD data sets 111, 112 together with the normalized image data 101N and 102N are input to a landmark detection module 120. The landmark detection module parses the data sets to correlate landmarks in each of the data sets. The landmarks may include natural landmarks such as calcifications, nipples, skin line, chest wall, major vessel junctions, parenchymal lesions, skin lesions and the like, and/or man-made landmarks, such as biopsy markers, j-wires, breast implant valves and recognizable port-a-cath geometric features and the like. Landmarks may also include skin markers and external fiducials, although the opportunity for such markers to be dislodged or moved between views within a study should be given consideration during any correlation process.

Once the landmarks are identified at step 120, the x,y,z coordinates of the landmarks are stored as landmark data sets 121 and 122. Using the landmark coordinate data, at step 130 transforms 131, 132 are generated to register each of the normalized data sets of image data 101N and 102N to a common coordinate system 150. In one embodiment, the common coordinate system defines a 3D volume associated with an ideal, non-compressed breast. The transforms may be free-form and may be volume-constraining. Registration of 3D volumes to a 3D common coordinate system, or a 2D image to a 2D coordinate system, can be performed using techniques known to those of skill in the art, including, for example, a least means squared type analysis to appropriately rotate, shift and extrapolate the normalized data set such that the landmark features from each data set are in similar positions in the common coordinate system. Techniques for mapping pixels from one coordinate geometry into those of another coordinate geometry are as described in U.S. Pat. No. 7,702,142 entitled Matching Geometry Generation and Display of Tomosynthesis Images, incorporated herein by reference. Registration of a 3D volume to a 2D common coordinate system may use similar shift and rotate techniques in combination with pixel mapping techniques to map segments of 3D images to a simulated 2D image, such as described in co-pending application Ser. No. 61/563,785 filed Nov. 27, 2011 and entitled “SYSTEM AND METHOD FOR GENERATING A 2D IMAGE USING MAMMOGRAPHY AND/OR TOMOSYNTHESIS DATA”, by Hologic, Inc., and incorporated herein by reference.

At step 140, the transforms 131, 132 are applied to the personalized CAD data sets 111, 112 to likewise convert the various CAD data to the common geometry system. In the event that 3D CAD results need to be mapped to a 2D coordinate system, techniques such as those described in the '785 application described above may be used. Once each personalized CAD data set has been transformed to the common geometry system, the CAD data sets may be combined into one fused CAD data set 140. In one embodiment, the CAD data sets are combined on a segment by segment basis, with the most relevant CAD result for each segment being included in the fused image. Other methods of combining CAD results, may alternatively be used within the scope of the present invention. In alternate embodiments, a user interface may be provided which enables (automatic and/or manual) designation of CAD results preference in the fusion (for example, a user may wish to generate a fused CAD results which give preference to CAD marks over angiogenesis, for example). Such an arrangement allows a user to build multiple instantiations of different fused CAD results, each of which may give weighted preference to different CAD inputs to the fused CAD data set, as may be desired depending upon the mode of images that are being viewed by a user.

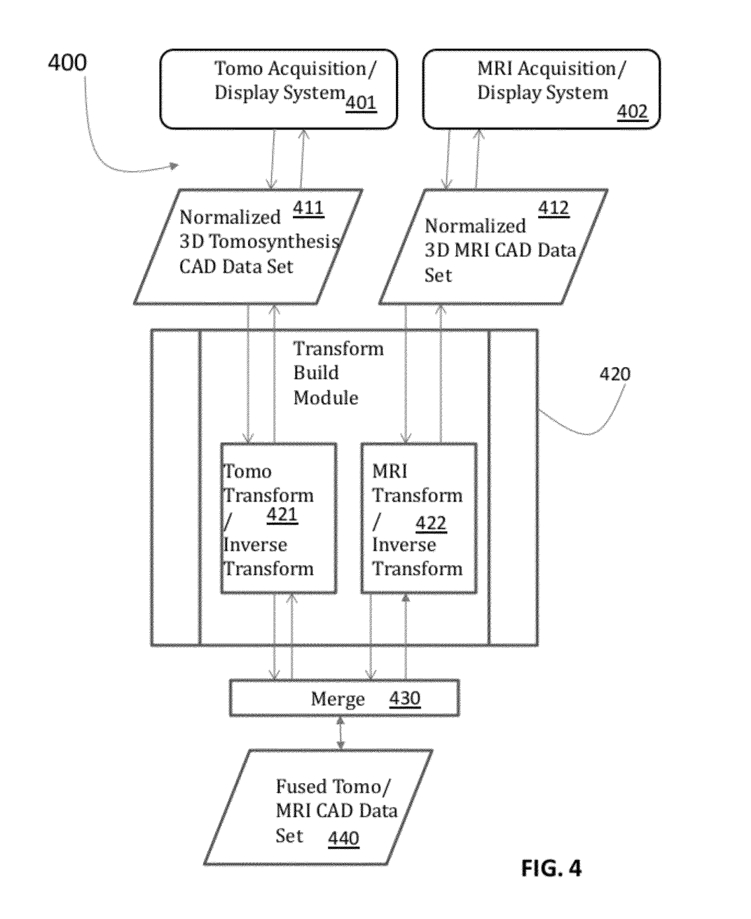

FIG. 4 is a data flow diagram 400 which pictorially illustrates the flow of data between an image acquisition and display systems 401, 402, a transform module 420 of the CAD processing system 100, and a system storage, which may store copies of various data sets including normalized CAD data sets 411, 412, transforms 421, 422 and one or more fused CAD data sets 440. As shown in FIG. 4, normalized CAD data sets, which have been received from the various acquisition devices 401, 402 and processed as described in FIG. 2 to convert the data to a common pixel size are input to the transform module 420. The transform module 420 has access to transforms 421, 422, each of which has been generated as described above to separately rotate, shift, integrate or extrapolate its particular image data set to a selected common geometry. The transform module 420 transforms the normalized CAD data sets from each acquisition module using respective transform generated for correlation of the image data. The result is two separate CAD data sets, each including CAD data particular to the modality of the image acquisition device, yet correlated on a pixel size and geometric scale. The two CAD data sets may therefore be combined in a controlled manner by Merge program code 430 to provide a fused CAD data set. As mentioned above, the merge program code may be manually or automatically controlled to weight or otherwise provide preferential treatment to one or more of the transformed CAD data sets.

Viewing the CAD data generally involves overlaying the CAD data set on top of the image data set. Thus prior to viewing the fused CAD data set needs to be re-transformed such that it corresponds in pixel size and geometry to a viewable image for the acquisition device. The inverse transform is applied to the CAD data, pixel sizes are re-adjusted and the CAD data is ready for viewing with the acquired image data set. In this way, 2D CAD can be combined with the functional and morphological CAD from MRI yielding very high sensitivity and improving 2D CAD specificity.

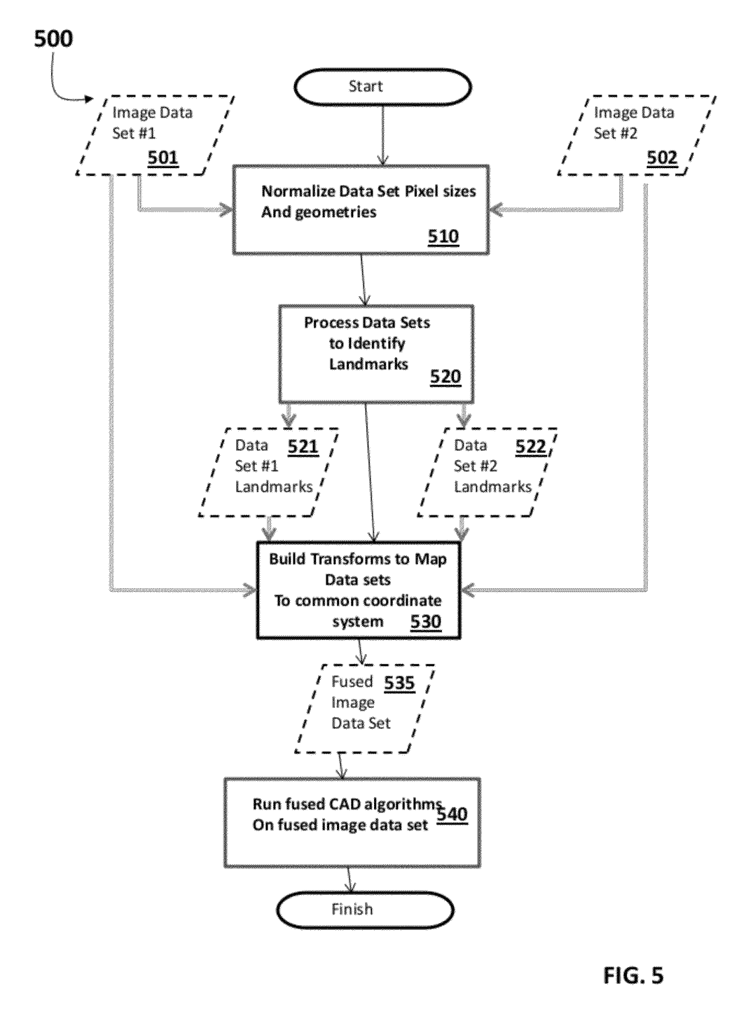

According to a further aspect of the invention, the individual CAD data sets can be used together with the fused CAD data sets and the fused image data set to train CAD algorithms for use with fused multi-mode images. An exemplary process as described in FIG. 4 that normalizes pixel sizes of images from different modalities, morphs the images to align various landmarks and combines the images, can be iteratively performed on different images to acquire a standardized fused image set which can be used, together with the fused CAD data set, to train a CAD algorithm to be performed on the fused image, thereby removing the requirement of providing different CAD algorithms for each individual acquisition mode, and performing separate CAD processing steps. Rather, as shown in FIG. 5, appropriate training of a CAD algorithm specifically for fused image data would include only the steps of normalizing the individual data sets 510, identifying landmarks in the data sets at 520 and one of shifting, interpolating, morphing, skewing or other methods of fitting the individual data sets to a particular fused image geometry with aligned landmarks to provide a fused image 535. The trained CAD algorithm would then directly process the fused image data to provide the resultant fused CAD data set. As discussed in FIG. 4, this fused CAD data set may be displayed with the fused image data set, or projected back to any one of the source image data sets.

Accordingly, a system and method has been shown and described which enables CAD data that is particular to multiple different imaging modalities to be combined into a single fused CAD data set, which may then be viewed along with image data from any of the imaging modalities used to create the data set. Such an arrangement results in a rich set of CAD data, allowing the strengths of all imaging modalities to be leveraged to increase the specificity and sensitivity of cancer diagnosis. Having described several exemplary embodiments, it will be appreciated that numerous specific details have been set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments of the systems and methods that have been described herein may be implemented in hardware or software, or a combination of both. In an embodiment these systems and methods are implemented in computer programs executing on programmable computers each comprising at least one processor, a data storage system (including volatile and non-volatile memory and/or storage elements), at least one input device, and at least one output device. For example and without limitation, the programmable computers may be a mainframe computer, server, personal computer, laptop, personal data assistant, or cellular telephone. Program code is applied to input data to perform the functions described herein and generate output information. The output information is applied to one or more output devices, in known fashion.

Each program can be implemented in a high level procedural or object oriented programming and/or scripting language to communicate with a computer system. However, the programs can be implemented in assembly or machine language, if desired. In any case, the language may be a compiled or interpreted language. Each such computer program can be stored on a storage media or a device (e.g. ROM or magnetic diskette) readable by a general or special purpose programmable computer, for configuring and operating the computer when the storage media or device is read by the computer to perform the procedures described herein. The embodiments may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Therefore, having described numerous embodiments, it is understood that the present invention is not limited merely to those embodiment, but includes rather includes equivalents thereto. The invention should therefore be only be limited by the attached claims.

What is claimed is:

1. A method of generating a fused Computer Assisted Detection (CAD) data set includes the steps of:
obtaining a plurality of image data sets of an object, each data set acquired using a different imaging modality;
processing each image data set to generate a personalized CAD data set for the respective image data sets;
identifying a landmark that is common to each image data set;
mapping each image data set to a common coordinate system such that the landmark is in a similar location in each mapped image data set, including identifying a transform function for each image data set that defines the mapping of the respective image data set to the common coordinate system; and
applying the transform function for each image data set to the personalized CAD data for the image data set to provide a transformed personalized CAD data set for each image data set;
combining the transformed personalized data sets to provide the fused CAD data set; and
displaying the fused CAD data set with at least one of the image data sets.

2. The method of claim 1 further including the step of normalizing the pixel sizes of each of the image data sets.

3. The method of claim 1 wherein the landmark is selected from a group including physical landmarks and fiducial landmarks.

4. The method of claim 3 wherein the object is a breast and the physical landmarks are selected from a group including a nipple position, a skin line, a chest wall, major vessel junctions, parenchyml lesions, skin lesions and calcifications.

5. The method of claim 3 wherein the object is a breast and the fiducial landmark is selected from a group including a breast biopsy marker or wire and a breast implant valve.

6. A computer system comprising:
a display;
a computer readable medium having a data structure stored thereon, the data structure comprising a data volume including fused Computer Assisted Detection (CAD) information, the CAD information including an integration of CAD information obtained from a plurality of different image data sets, the image data sets including images of a common object but acquired using a image acquisition systems of a corresponding plurality of different modalities; and
transform software, stored on the computer readable medium and operable to transform the data volume from a first coordinate system to a coordinate system specific to the display to enable display.

6. A computer system comprising:
a workstation comprising:
a communication link couplable to a plurality of imaging systems of different modalities;
a processing device, coupled to the communication link;
a computer readable medium coupled to the processing device and having program code stored thereon, the program code comprising:
computer assisted detection (CAD) program code, operable when executed upon by the processing device to process image data sets received from each of the imaging systems in accordance with its respective modality of each imaging system, to provide respective personalized CAD data sets for association with each image data set; and
transform program code operable when executed upon by the processing device to transform the personalized CAD data sets to a common geometry; and
merge program code operable to selectively merge the CAD data sets to provide one or more fused CAD data sets.
